(19) United States
(12) Patent Application Publication
(10) Pub. No.: US 2026/0238409 A1
(43) Pub. Date: Aug. 13, 2026

(54) SEGMENT PARSER AND TRANSMISSION METHODS FOR DISTRIBUTED-TONE RESOURCE UNITS ON WIDER BANDWIDTHS

(71) Applicant: MEDIATEK INC., Hsinchu City (TW)

(72) Inventors: Shengquan HU, San Jose, CA (US); Jianhan LIU, San Jose, CA (US); Thomas Edward PARE, JR., San Jose, CA (US)

(21) Appl. No.: 19/153,060

(22) PCT Filed: Feb. 7, 2024
(86) PCT No.: PCT/CN2024/076746

§ 371 Date: Aug. 1, 2025

Related U.S. Application Data
(60) Provisional application No. 63/484,207, filed on Feb. 10, 2023.

(51) Int. Cl. H04L 5/00

(52) U.S. Cl. CPC H04L 5/0044; H04L 5/0041

(57) ABSTRACT

Various schemes pertaining to designs of a segment parser and transmission methods for distributed-tone resource units (dRUs) on wider bandwidths in wireless communications are described. An apparatus (e.g., station (STA)) generates a dRU and transmits the dRU on a distribution bandwidth that is equal to or greater than 160 MHz. In generating the dRU, the apparatus segment parses data tones of the dRU using a segment parser by segment parsing the data tones of the dRU onto: (i) two 80 MHz segments responsive to the distribution bandwidth being 160 MHz; or (ii) three 80 MHz segments responsive to the distribution bandwidth being 240 MHz; or (iii) four 80 MHz segments responsive to the distribution bandwidth being 320 MHz; or (iv) six 80 MHz segments responsive to the distribution bandwidth being 480 MHz.

### CROSS REFERENCE TO RELATED PATENT APPLICATION

The present disclosure is part of a non-provisional patent application claiming the priority benefit of U.S. Provisional Patent Application Nos. 63/484,207, filed 10 Feb. 2023, the content of which being incorporated by reference in its entirety.

### TECHNICAL FIELD

The present disclosure is generally related to wireless communications and, more particularly, to designs of a segment parser and transmission methods for distributed-tone resource units (dRUs) on wider bandwidths in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and wireless local area network (WLAN) systems in accordance with the Institute of Electrical and Electronics Engineers (IEEE) 802.11be standards, it has been proposed that utilization of dRUs be extended to wider bandwidths such as 160 MHz, 240 MHz, 320 MHz, etc. For regular resource units (rRUs) and regular multi-resource units (rMRUs), low-density parity-check (LDPC) tone mapping is performed per 80 MHz segment and then round robin segment parsing or proportional round robin segment parsing is applied for rRUs or multi-RUs (MRUs) with a size greater than 80 MHz. However, at the present time, details of a segment parser for dRUs distributed on a wider bandwidth, such as 160 MHz, 240 MHz, 320 MHz and 480 MHz, have yet to be defined. Moreover, physical-layer (PHY) parameters of a binary convolutional coding (BCC) interleaver and a LDPC tone mapper for dRUs on a wider bandwidth have yet to be defined. Therefore, there is a need for a solution of a segment parser and transmission methods for dRUs on wider bandwidths in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to designs of a segment parser and transmission methods for dRUs on wider bandwidths in wireless communications. The segment parser under various proposed schemes in accordance with the present disclosure may perform segment parsing of dRUs on a wider bandwidth, such as 160 MHz, 240 MHz, 320 MHz and 480 MHz, with PHY parameters defined for a BCC interleaver and a LDPC tone mapper on the wider bandwidth.

In one aspect, a method may involve generating a dRU and transmitting the dRU on a bandwidth that is equal to or greater than 160 MHz. In generating the dRU, the method may involve segment parsing data tones of the dRU onto: (i) two 80 MHz segments responsive to the distribution bandwidth being 160 MHz; or (ii) three 80 MHz segments responsive to the distribution bandwidth being 240 MHz; or (iii) four 80 MHz segments responsive to the distribution bandwidth being 320 MHz; or (iv) six 80 MHz segments responsive to the distribution bandwidth being 480 MHz.

In another aspect, an apparatus may include a transceiver configured to communicate wirelessly and a processor coupled to the transceiver. The processor may generate a dRU and transmit, via the transceiver, the dRU on a distribution bandwidth that is equal to or greater than 160 MHz. In generating the dRU, the processor may segment parse data tones of the dRU onto: (i) two 80 MHz segments responsive to the distribution bandwidth being 160 MHz; or (ii) three 80 MHz segments responsive to the distribution bandwidth being 240 MHz; or (iii) four 80 MHz segments responsive to the distribution bandwidth being 320 MHz; or (iv) six 80 MHz segments responsive to the distribution bandwidth being 480 MHz.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example scenario under a proposed scheme in accordance with the present disclosure.

FIG. 6 is a diagram of an example design under a proposed scheme in accordance with the present disclosure.

FIG. 7 is a diagram of example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a diagram of an example design under a proposed scheme in accordance with the present disclosure.

FIG. 14 is a diagram of an example design under a proposed scheme in accordance with the present disclosure.

FIG. 15 is a diagram of an example design under a proposed scheme in accordance with the present disclosure.

FIG. 16 is a diagram of an example design under a proposed scheme in accordance with the present disclosure.

FIG. 17 is a block diagram of an example communication system under a proposed scheme in accordance with the present disclosure.

FIG. 18 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to designs of a segment parser and transmission methods for dRUs on wider bandwidths in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (rRU) refers to a RU with tones that are continuous (e.g., immediately adjacent to one another) and not interleaved, interlaced or otherwise distributed. Moreover, a 26-tone regular RU may be interchangeably denoted as RU26 (or rRU26), a 52-tone regular RU may be interchangeably denoted as RU52 (or rRU52), a 106-tone regular RU may be interchangeably denoted as RU106 (or rRU106), a 242-tone regular RU may be interchangeably denoted as RU242 (or rRU242), and so on. Moreover, an aggregate (26+52)-tone regular multi-RU (MRU) may be interchangeably denoted as MRU78 (or rMRU78), an aggregate (26+106)-tone regular MRU may be interchangeably denoted as MRU132 (or rMRU132), and so on. Furthermore, a distributed-tone RU (dRU) refers to a RU with tones that are non-discontinuous (e.g., not immediately adjacent to one another) and interleaved, interlaced or otherwise distributed. Accordingly, a 26-tone distributed-tone RU may be interchangeably denoted as dRU26, a 52-tone distributed-tone RU may be interchangeably denoted as dRU52, a 106-tone distributed-tone RU may be interchangeably denoted as dRU106, a 242-tone distributed-tone RU may be interchangeably denoted as dRU242, a 484-tone distributed-tone RU may be interchangeably denoted as dRU484, a 996-tone distributed-tone RU may be interchangeably denoted as dRU996, a 2×996-tone distributed-tone RU may be interchangeably denoted as dRU2×996, and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

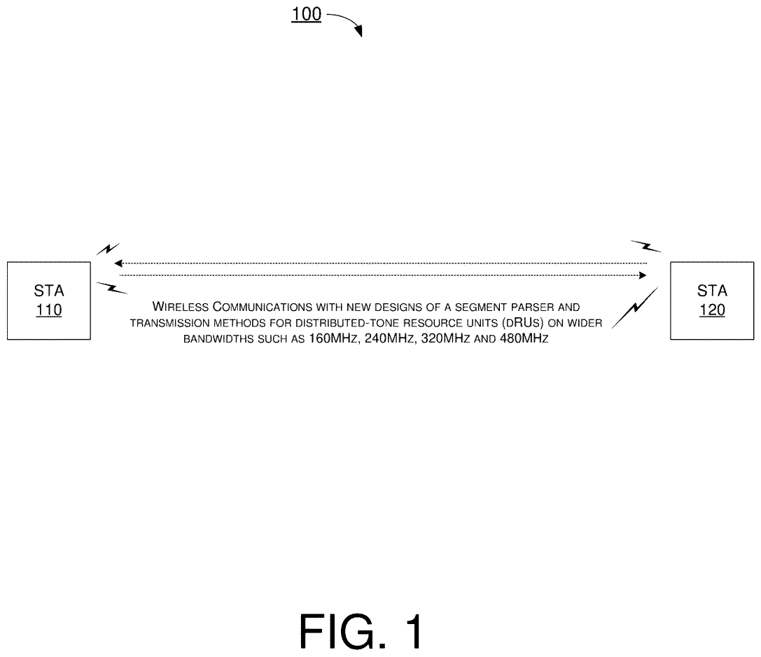

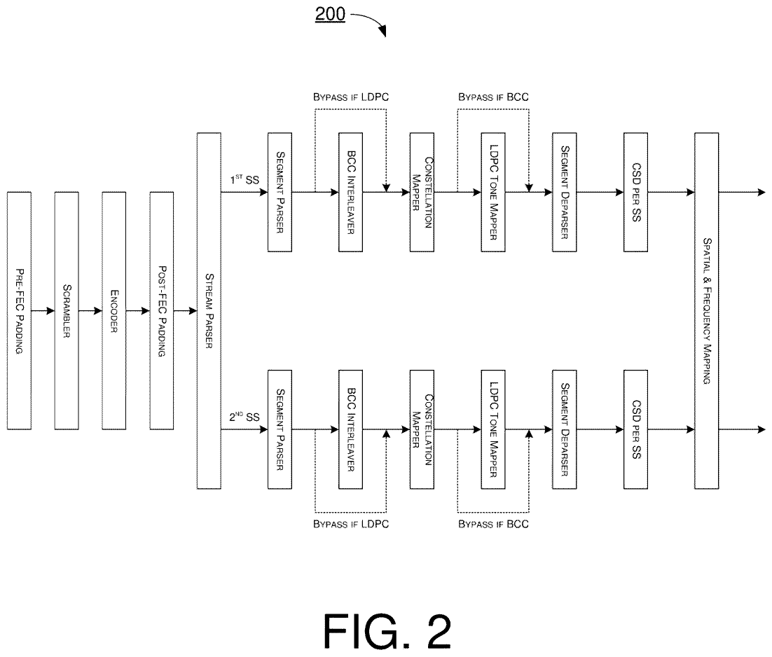

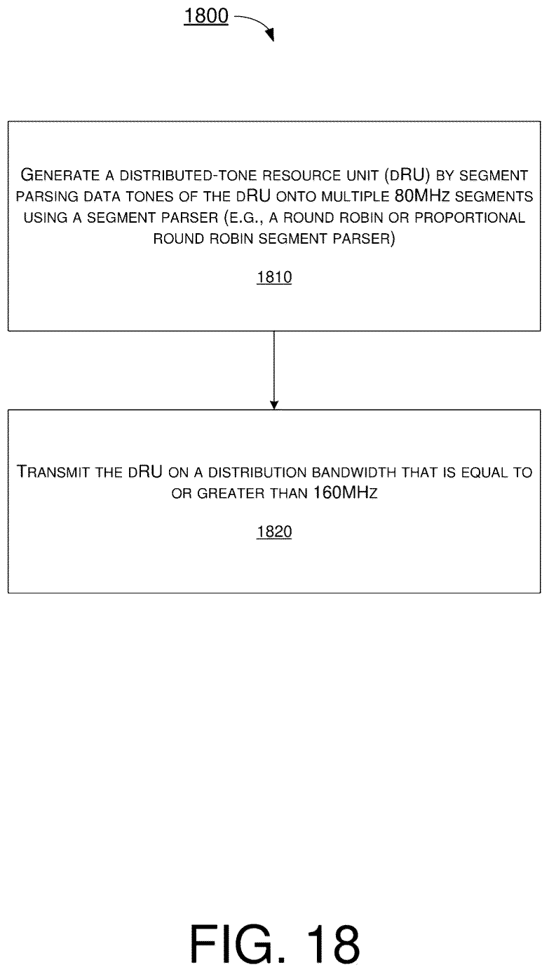

FIG. 1 illustrates an example network environment 100 in which various solutions and schemes in accordance with the present disclosure may be implemented. FIG. 2~FIG. 18 illustrate examples of implementation of various proposed schemes in network environment 100 in accordance with the present disclosure. The following description of various proposed schemes is provided with reference to FIG. 1~FIG. 18.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the designs of a segment parser and transmission methods for dRUs on wider bandwidths in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example design 200 under a proposed scheme in accordance with the present disclosure. FIG. 2 shows a transmitter block diagram with a segment parser for transmission of dRUs on a wider bandwidth under a first option (Option-1). Design 200 may include a number of functional blocks (which may be implemented in the form of electronic circuits) such as, for example and without limitation, a pre-forward error checking (pre-FEC) PHY padding block, a scrambler, an encoder, a post-FEC PHY padding block, a stream parser that parses an incoming stream of tones into a plurality of spatial streams (N_{SS}), such as a first spatial stream (1^{st} ss) and a second spatial stream (2^{nd} ss) as shown in FIG. 2 assuming up to two spatial streams being supported for dRUs. Corresponding to each spatial stream, there may be a respective chain of encoding functional blocks including, for example and without limitation, a segment parser, a BCC interleaver, a constellation mapper, a LDPC tone mapper, a segment deparser, and a cyclic-shift diversity (CSD) block for the respective spatial stream where dRU subcarrier indices may be used for frequency mapping. Outputs of the plurality of chains of encoding functional blocks are provided to a spatial and frequency mapping block that maps the tones into a number of transmit chains.

Under the proposed scheme, for dRUs with a size equal to or less than 996 tones, the segment parser and segment deparser may be bypassed. That is, segment parsing may not be performed on dRUs with a size≤996 tones. Moreover, the same BCC interleaver of a rRU (corresponding to dRU≤242 tones) may be applied for a dRU of the same size. Similarly, the same LDPC tone mapper of a rRU may be applied for a dRU of the same size. Under the proposed scheme, the BCC interleaver and LDPC tone mapper in each chain of encoding functional blocks may be bypassed. That is, the BCC interleaver may be bypassed in case that LDPC tone mapping is performed, and the LDPC tone mapper may be bypassed in case that BCC interleaving is performed.

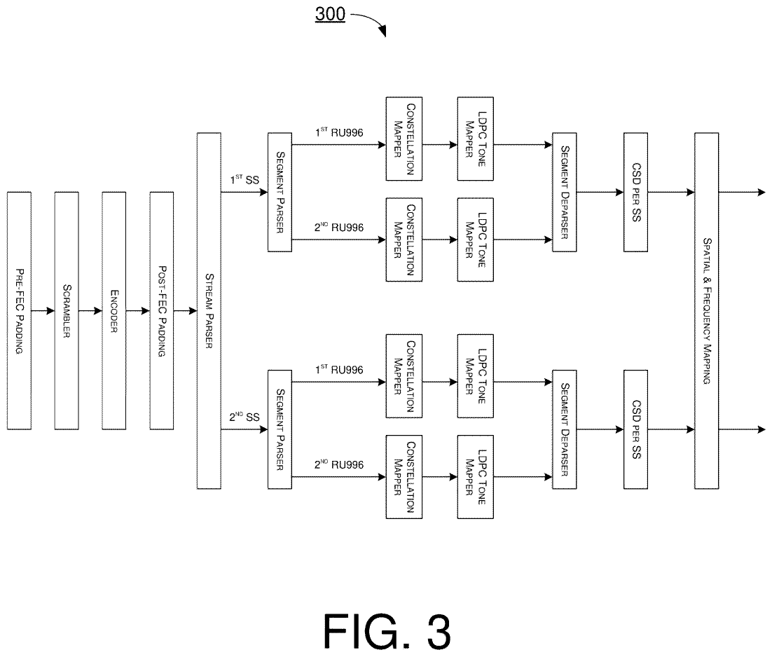

FIG. 3 illustrates an example design 300 under a proposed scheme in accordance with the present disclosure. FIG. 3 shows a transmitter block diagram with a segment parser for transmission of dRUs on a wider bandwidth under the first option (Option-1). Design 300 may include a number of functional blocks (which may be implemented in the form of electronic circuits) such as, for example and without limitation, a pre-FEC PHY padding block, a scrambler, an encoder, a post-FEC PHY padding block, a stream parser that parses an incoming stream of tones into a plurality of N_{SS}, such as 1^{st} ss and 2^{nd} ss as shown in FIG. 3 assuming up to two spatial streams being supported for dRUs. Corresponding to each spatial stream, there may be a respective chain of encoding functional blocks including, for example and without limitation, a segment parser, two constellation mappers, two LDPC tone mappers, a segment deparser and a CSD block per spatial stream. The segment parsers may be a round robin segment parser for a rRU of 2×996 tones, and the segment deparser may be a round robin segment deparser for the rRU of 2×996 tones. Each of the two constellation mappers and the two LDPC tone mappers may be utilized for a respective 996-tone dRU (e.g., 1^{st} 996-tone dRU and 2^{nd} 996-tone dRU). Outputs of the plurality of chains of encoding functional blocks are provided to a spatial and frequency mapping block (where dRU subcarrier indices may be used for frequency mapping) that maps the tones into a number of transmit chains.

Under the proposed scheme, for dRUs with a size equal to 2×996 tones on BW320 and BW480, the round robin segment parser and deparser may be enabled. Moreover, the same LDPC tone mapper of a 996-tone rRU may be applied for each segment of 996 tones. Furthermore, for Option-1, instead of reusing rRU interleaver and tone mapper parameters, the parameters of BCC interleaver and LDPC tone mapper for dRU may be optimized.

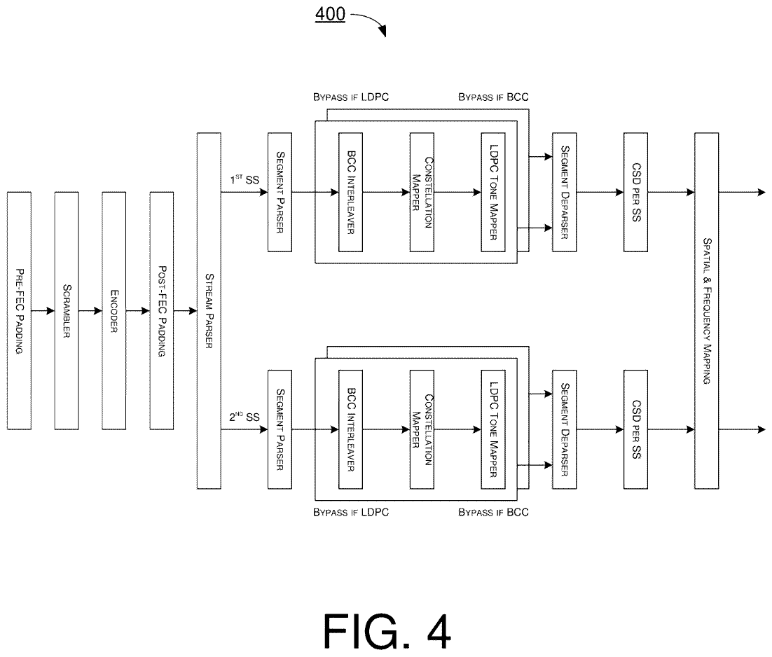

FIG. 4 illustrates an example design 400 under a proposed scheme in accordance with the present disclosure. FIG. 4 shows a transmitter block diagram with a segment parser for transmission of dRUs on a wider bandwidth under a second option (Option-2). Design 400 may include a number of functional blocks (which may be implemented in the form of electronic circuits) such as, for example and without limitation, a pre-FEC PHY padding block, a scrambler, an encoder, a post-FEC PHY padding block, a stream parser that parses an incoming stream of tones into a plurality of N_{SS}, such as 1^{st} ss and 2^{nd} ss as shown in FIG. 4 assuming up to two spatial streams being supported for dRUs. Corresponding to each spatial stream, there may be a respective chain of encoding functional blocks including, for example and without limitation, a segment parser, a BCC interleaver, a constellation mapper, a LDPC tone mapper, a segment deparser and a CSD block per spatial stream. The segment parsers may be a round robin or proportional round robin segment parser, and the segment deparser may be a round robin or proportional round robin segment deparser. Outputs of the plurality of chains of encoding functional blocks are provided to a spatial and frequency mapping block (where dRU subcarrier indices may be used for frequency mapping) that maps the tones into a number of transmit chains.

Under the proposed scheme, the round robin or proportional round robin segment parser may be enabled for distribution bandwidth equal to or greater than 160 MHz. Moreover, some of the parameters of BCC interleaver for dRU≤242 tones may be re-designed. Furthermore, some of the parameters of LDPC tone mapper may be re-designed.

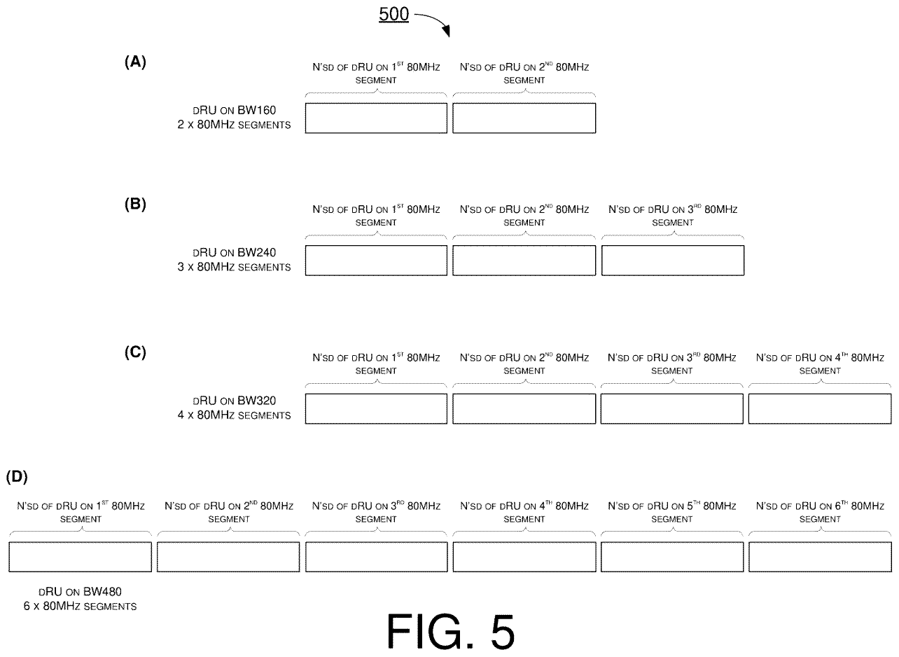

FIG. 5 illustrates an example scenario 500 under a proposed scheme in accordance with the present disclosure. Specifically, FIG. 5 shows an example of dRU segments for wider bandwidths, with each dRU segment having a number of data tones or data-carrying subcarriers (N′sd). Part (A) of FIG. 5 shows a dRU on BW160 with 2×80 MHz segments. Part (B) of FIG. 5 shows a dRU on BW240 with 3×80 MHz segments. Part (C) of FIG. 5 shows a dRU on BW320 with 4×80 MHz segments. Part (D) of FIG. 5 shows a dRU on BW480 with 6×80 MHz segments.

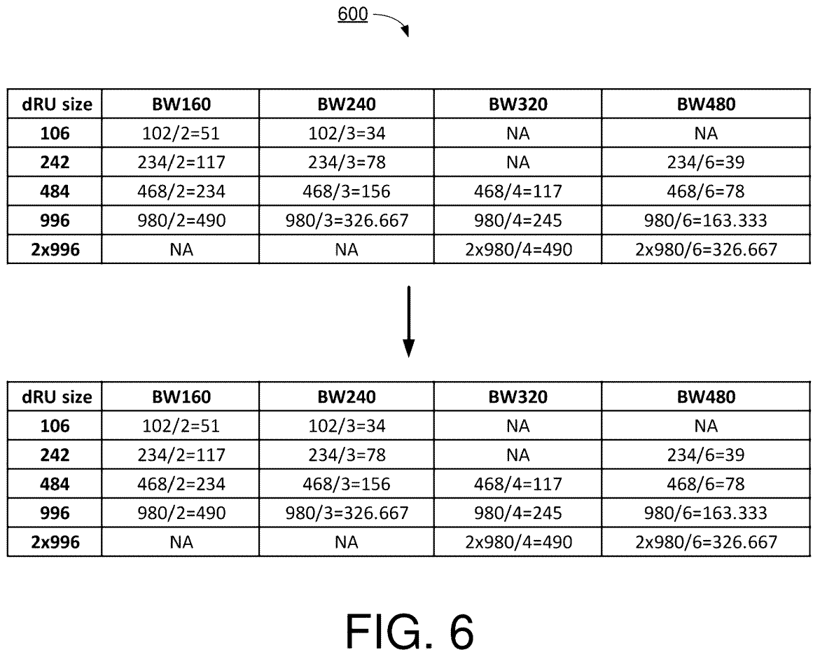

FIG. 6 illustrates an example design 600 under a proposed scheme in accordance with the present disclosure. Design 600 may pertain to a segment parser design for dRU on wider bandwidths under Option-2. Under the proposed scheme, there may be two 80 MHz segments for BW160, three 80 MHz segments for BW240, four 80 MHz segments for BW320 and six 80 MHz segments for BW480. The number of data tones/data subcarriers per 80 MHz segment may be calculated as shown in FIG. 6.

Under Option-2, with respect to segment parser design for dRUs on a wider bandwidth, for the cases of dRU segment parsing with leftover tone(s), the encoded information bits (after stream parsing) may be parsed onto each 80 MHz frequency subblocks as follows:

$$dRU 996 on BW 240 : 980 = 32 {0}_{( on 1 st 80 MHz segment )} + {330}_{( on 2 nd 80 MHz segment )} + {330}_{( on 3 rd 80 MHz segment )} \\ dRU 996 on B W 480 : 980 = 155 + 165 + 165 + 165 + 165 + 165 or \\ 980 = 160 + 160 + 165 + 165 + 165 + 165$$

$$dRU 2 x 996 on BW 480 : 2 x 980 = 320 + 320 + 330 + 330 + 330 + 330 or \\ 2 x 980 = 310 + 330 + 330 + 330 + 330 + 330$$

In the above expressions, “980” denotes the total number of data tones for dRU996 and “2×980” denotes the total number of data tones for dRU2×996.

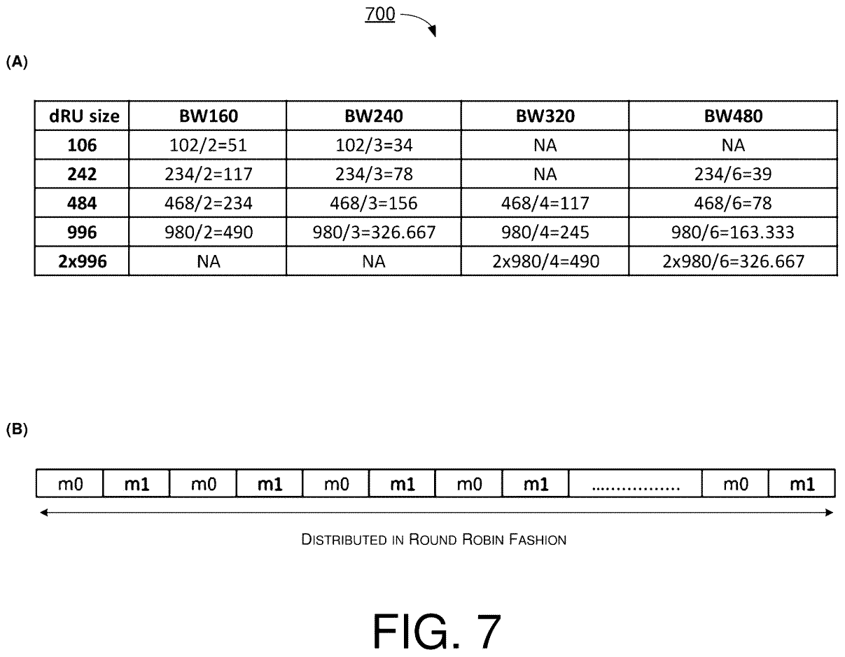

FIG. 7 illustrates an example design 700 under a proposed scheme in accordance with the present disclosure. Design 700 may pertain to a round robin parser for dRUs on a wider bandwidth under Option-2. Part (A) of FIG. 7 shows a parser design table for BW160, in which L denotes the number of frequency subblocks (or 80 MHz segments) with

$$s = max ( 1 , \frac{{N}_{BPSCS , u}}{2} ) ,$$

s denotes parsed coded bits, and N_{BPSCS,u} denotes a number of coded bits per subcarrier per spatial stream for user u. Part (B) of FIG. 7 shows an example of segment parser processing in a round robin fashion.

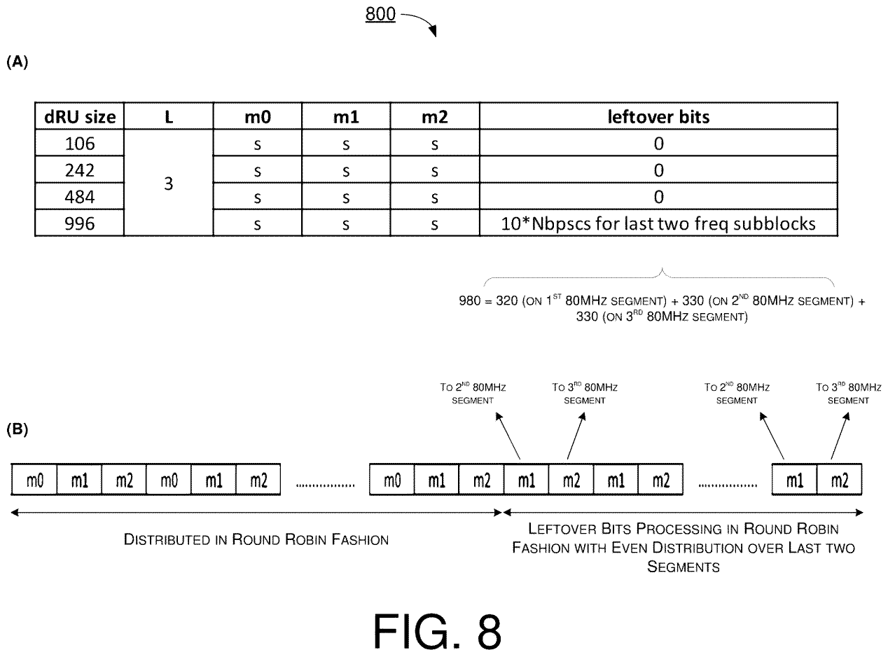

FIG. 8 illustrates an example design 800 under a proposed scheme in accordance with the present disclosure. Design 800 may pertain to a round robin parser for dRUs on a wider bandwidth under Option-2. Part (A) of FIG. 8 shows a parser design table for BW240, in which L denotes the number of frequency subblocks (or 80 MHz segments) with

$$s = max ( 1 , \frac{{N}_{BPSCS , u}}{2} ) ,$$

s denotes parsed coded bits, and N_{BPSCS,u} denotes a number of coded bits per subcarrier per spatial stream for user u. Regarding the leftover bits for dRU996, the encoded information bits (after stream parsing) may be parsed onto each 80 MHz frequency subblocks as follows: 980=320_{(on 1st 80 MHz segment)}+330_{(on 2nd 80 MHz segment)}+330_{(on 3rd 80 MHz segment)}. Part (B) of FIG. 8 shows an example of dRU996 segment parser processing in a round robin fashion with leftover bits. In design 800, leftover bits may be processed in a round robin fashion to be evenly distributed over the last two segments among all 80 MHz segments.

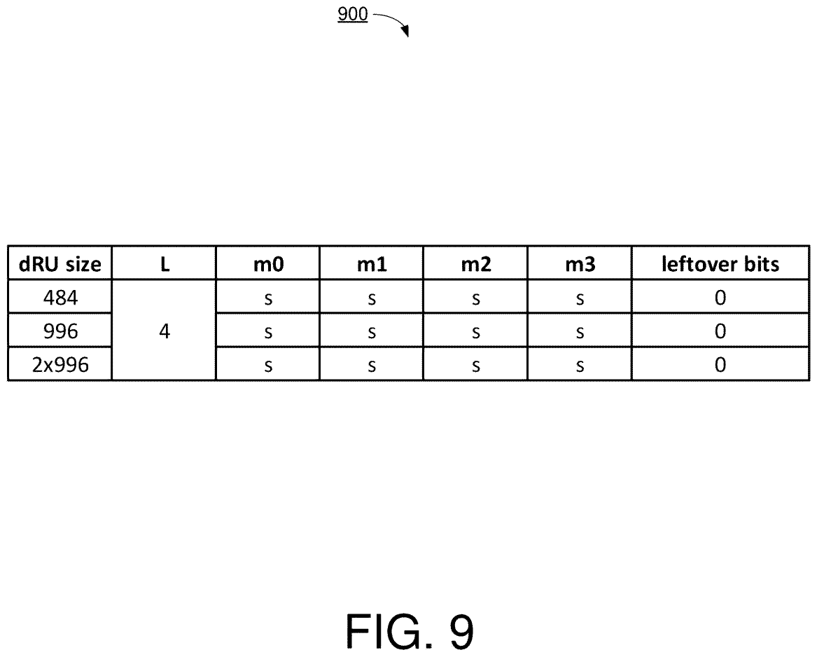

FIG. 9 illustrates an example design 900 under a proposed scheme in accordance with the present disclosure. Design 900 may pertain to a round robin parser for dRUs on a wider bandwidth under Option-2. FIG. 9 shows a parser design table for BW320, in which L denotes the number of frequency subblocks (or 80 MHz segments) with

$$s = max ( 1 , \frac{{N}_{BPSCS , u}}{2} ) ,$$

s denotes parsed coded bits, and N_{BPSCS,u} denotes a number of coded bits per subcarrier per spatial stream for user u.

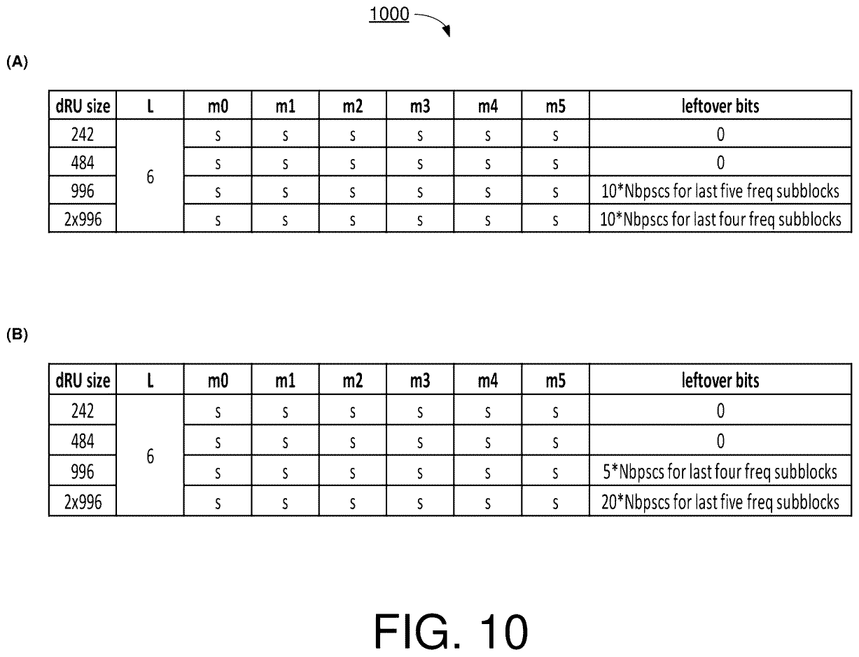

FIG. 10 illustrates an example design 1000 under a proposed scheme in accordance with the present disclosure. Design 1000 may pertain to a round robin parser for dRUs on a wider bandwidth under Option-2. Each of part (A) and part (B) of FIG. 10 shows a different parser design table for BW480, in which L denotes the number of frequency subblocks (or 80 MHz segments) with

$$s = max ( 1 , \frac{{N}_{BPSCS , u}}{2} ) ,$$

s denotes parsed coded bits, and N_{BPSCS,u} denotes a number of coded bits per subcarrier per spatial stream for user u.

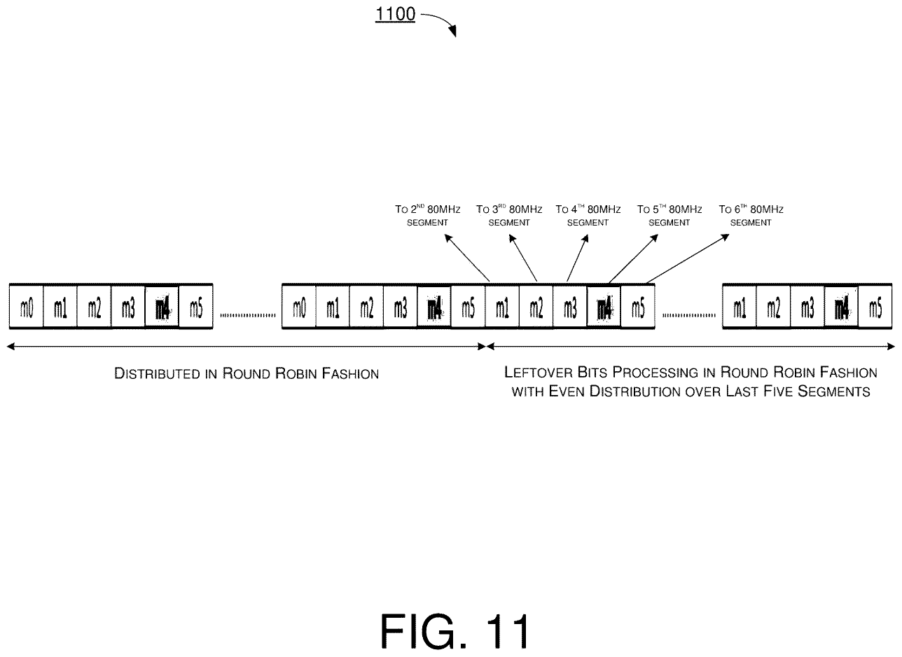

FIG. 11 illustrates an example design 1100 under a proposed scheme in accordance with the present disclosure. Design 1100 may pertain to a round robin parser for dRUs on a wider bandwidth under Option-2. Specifically, FIG. 11 shows an example of segment parser processing with leftover bits for dRU996 on BW480. In design 1100, leftover bits may be processed in a round robin fashion to be evenly distributed over the last five segments among all 80 MHz segments.

Under Option-2, with respect to round robin segment parser design for dRUs on a wider bandwidth, the equations of proportional round robin segment parser in IEEE 802.11be, as shown below, may be reused for dRU segment parser.

$${y}_{k , l . u} = {x}_{m , u} \\ m = ( {\sum }_{i = 0}^{L - 1} {m}_{i} ) \cdot ⌊ \frac{k}{{m}_{l}} ⌋ + {\sum }_{i = 0}^{l - 1} {m}_{i} + ( k mod {m}_{l} )$$

For leftover bits processing, the following equation for leftover bits processing in IEEE 802.11be may be reused for dRU segment parser.

$$m = ( {\sum }_{i = 0}^{L - 1} {m}_{i} ) \cdot ⌊ \frac{{N}_{CBPSS , {I}_{0} , u}}{{m}_{{I}_{0}}} ⌋ + ( {\sum }_{i = 0 , l \neq {l}_{0}}^{L - 1} {m}_{i} ) \cdot ⌊ \frac{{k}^{′}}{{m}_{l}} ⌋ + {\sum }_{i = 0 , l \neq {l}_{0}}^{l - 1} {m}_{i} + ( k mod {m}_{l} )$$

Definitions of parameters in these equations may be found in the IEEE 802.11be specification.

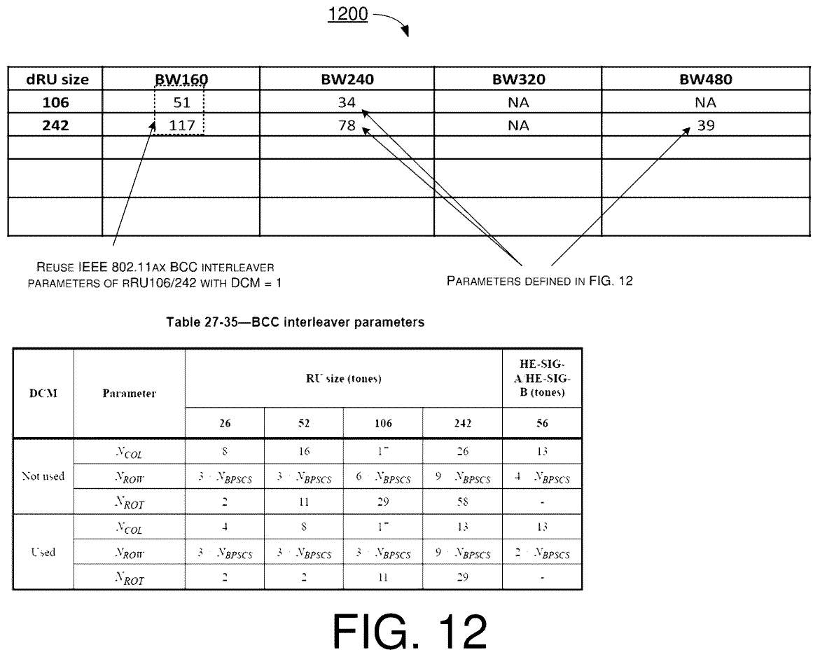

FIG. 12 illustrates an example design 1200 under a proposed scheme in accordance with the present disclosure. Design 1200 may pertain to a BCC interleaver design for dRUs on a wider bandwidth with segment parser. Under the proposed scheme, BCC may be applied only for dRUs with a size≤242 tones. Moreover, parameters for BCC interleaver for rRU106 and rRU242 with dual-carrier modulation (DCM)=1 as defined in Table 27-35 of the IEEE 802.11ax specification may be reused for dRU106 and dRU242.

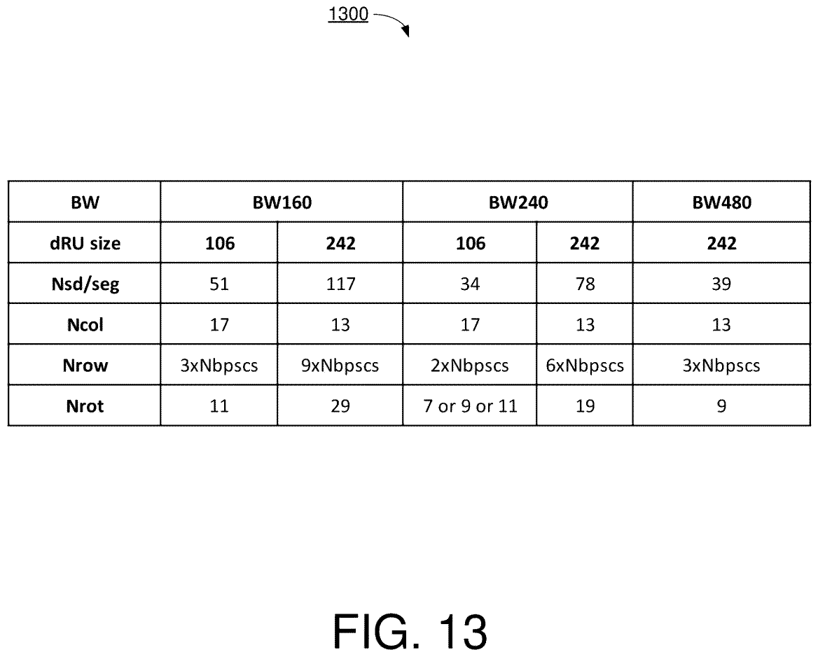

FIG. 13 illustrates an example design 1300 under a proposed scheme in accordance with the present disclosure. Design 1300 may pertain to a BCC interleaver design for dRUs on a wider bandwidth with segment parser. Specifically, FIG. 13 shows a table of BCC interleaver parameters for BW160, BW240 and BW240. Here, N_{BPSCS} denotes a number of coded bits per subcarrier per spatial stream, N_{sd/seg} denotes a number of subcarriers used in data transmission per segment, N_{col} denotes a number of columns, N_{row} denotes a number of rows, and Nᵣₒₜ denotes a number of rotations.

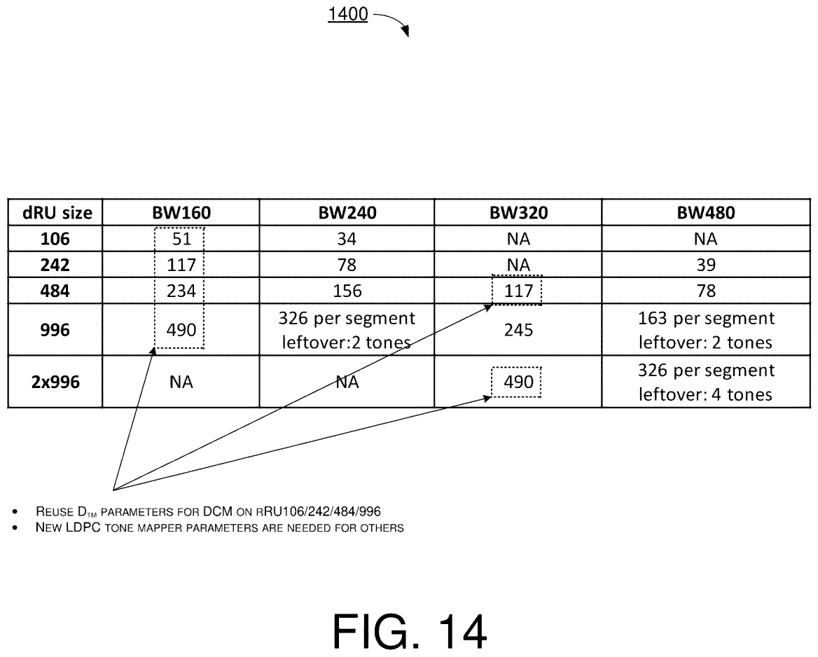

FIG. 14 illustrates an example design 1400 under a proposed scheme in accordance with the present disclosure. Design 1400 may pertain to a LDPC tone mapper design for dRUs on a wider bandwidth with segment parser under Option-2. Under the proposed scheme, the LDPC tone mapping distance (Dₜₘ) parameters for DCM on rRU106, rRU242, rRU484 and rRU 996 may be reused. New LDPC tone mapper parameters may be needed for others.

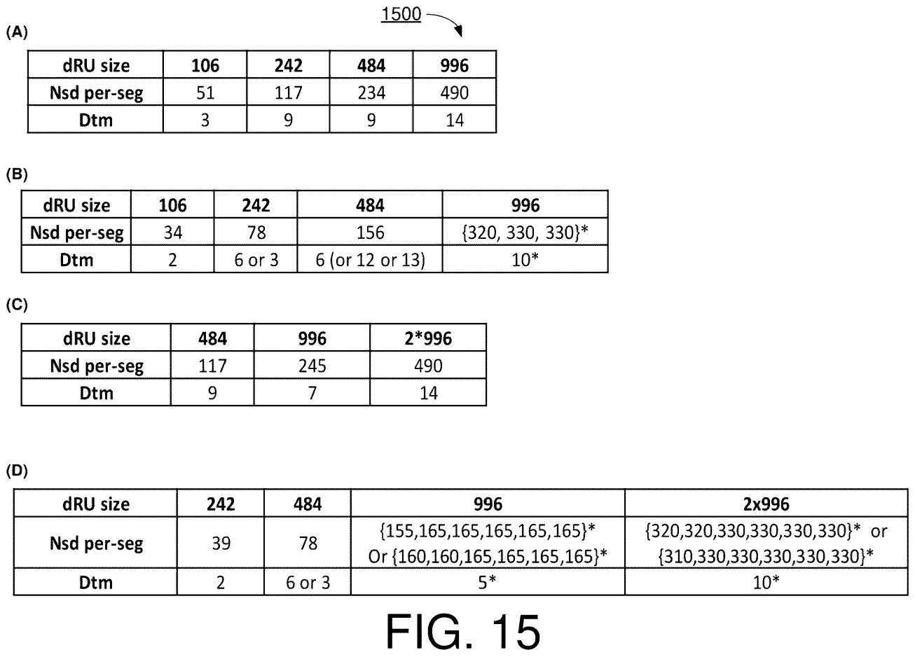

FIG. 15 illustrates an example design 1500 under a proposed scheme in accordance with the present disclosure. Design 1500 may pertain to a LDPC tone mapper design for dRUs on a wider bandwidth with segment parser under Option-2. Part (A) of FIG. 15 shows LDPC tone mapper parameters for dRUs on BW160. Part (B) of FIG. 15 shows LDPC tone mapper parameters for dRUs on BW240. Part (C) of FIG. 15 shows LDPC tone mapper parameters for dRUs on BW320. Part (D) of FIG. 15 shows LDPC tone mapper parameters for dRUs on BW480.

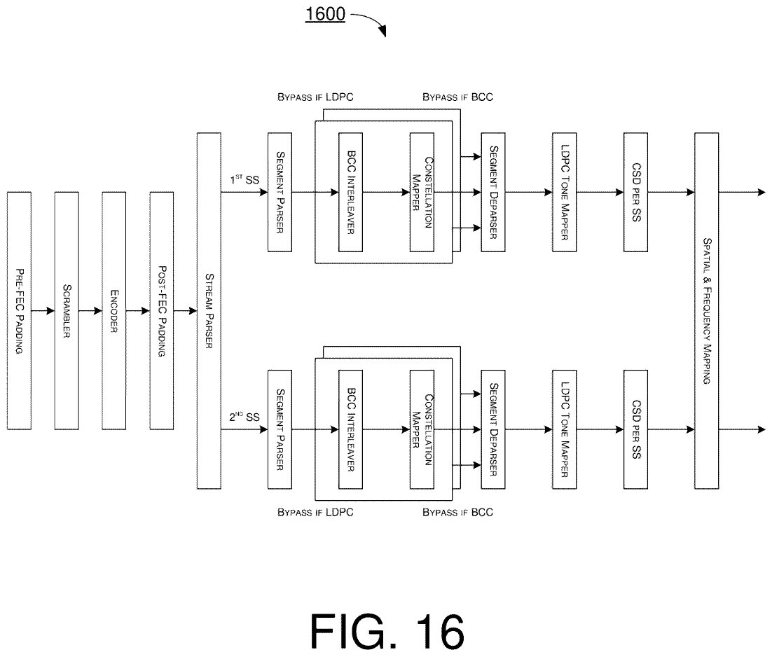

FIG. 16 illustrates an example design 1600 under a proposed scheme in accordance with the present disclosure. FIG. 16 shows a transmitter block diagram with a segment parser for transmission of dRUs on a wider bandwidth under a third option (Option-3). Design 1600 may include a number of functional blocks (which may be implemented in the form of electronic circuits) such as, for example and without limitation, a pre-FEC PHY padding block, a scrambler, an encoder, a post-FEC PHY padding block, a stream parser that parses an incoming stream of tones into a plurality of N_{SS}, such as 1^{st} ss and 2^{nd} ss as shown in FIG. 16 assuming up to two spatial streams being supported for dRUs. Corresponding to each spatial stream, there may be a respective chain of encoding functional blocks including, for example and without limitation, a segment parser, a BCC interleaver, a constellation mapper, a segment deparser, a LDPC tone mapper and a CSD block per spatial stream. Outputs of the plurality of chains of encoding functional blocks are provided to a spatial and frequency mapping block (where dRU subcarrier indices may be used for frequency mapping) that maps the tones into a number of transmit chains.

Under the proposed scheme, the segment parser may be enabled for distribution bandwidth equal to or greater than 160 MHz. Additionally, the BCC interleaver in Option-3 may be the same as that in Option-2. As for LDPC, under Option-3, segment deparsing may be performed first (e.g., by the segment deparser to cascade the constellation points) and then joined-segment LDPC tone mapping may be performed for dRUs≤996 tones. For dRU2×996, after segment deparser, LDPC tone mapping may be performed on each 996-tone RU. Moreover, the segment parser under Option-3 may be a round robin or proportional round robin segment parser, which may be enabled for a distribution bandwidth≥160 MHz. Regarding LDPC, an IEEE 802.11be/ax LDPC tone mapper may be utilized in Option-3. Moreover, under Option-3, the BCC interleaver may be bypassed in case that LDPC tone mapping is performed, and the LDPC tone mapper may be bypassed in case that BCC interleaving is performed.

### Illustrative Implementations

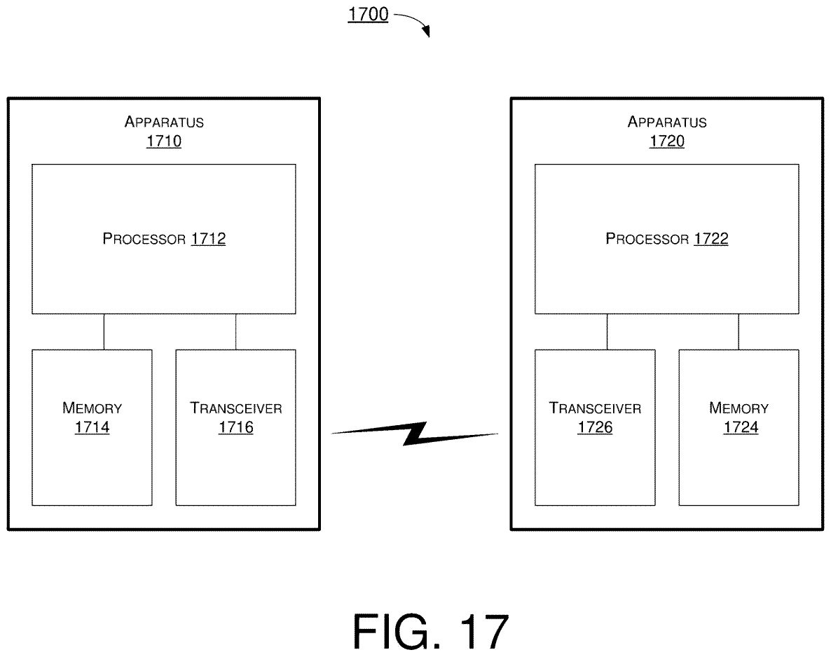

FIG. 17 illustrates an example system 1700 having at least an example apparatus 1710 and an example apparatus 1720 in accordance with an implementation of the present disclosure. Each of apparatus 1710 and apparatus 1720 may perform various functions to implement schemes, techniques, processes and methods described herein pertaining to designs of a segment parser and transmission methods for dRUs on wider bandwidths in wireless communications, including the various schemes described above with respect to various proposed designs, concepts, schemes, systems and methods described above as well as processes described below. For instance, apparatus 1710 may be implemented in STA 110 and apparatus 1720 may be implemented in STA 120, or vice versa.

Each of apparatus 1710 and apparatus 1720 may be a part of an electronic apparatus, which may be a STA or an AP, such as a portable or mobile apparatus, a wearable apparatus, a wireless communication apparatus or a computing apparatus. When implemented in a STA, each of apparatus 1710 and apparatus 1720 may be implemented in a smartphone, a smart watch, a personal digital assistant, a digital camera, or a computing equipment such as a tablet computer, a laptop computer or a notebook computer. Each of apparatus 1710 and apparatus 1720 may also be a part of a machine type apparatus, which may be an IoT apparatus such as an immobile or a stationary apparatus, a home apparatus, a wire communication apparatus or a computing apparatus. For instance, each of apparatus 1710 and apparatus 1720 may be implemented in a smart thermostat, a smart fridge, a smart door lock, a wireless speaker or a home control center. When implemented in or as a network apparatus, apparatus 1710 and/or apparatus 1720 may be implemented in a network node, such as an AP in a WLAN.

In some implementations, each of apparatus 1710 and apparatus 1720 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1710 and apparatus 1720 may be implemented in or as a STA or an AP. Each of apparatus 1710 and apparatus 1720 may include at least some of those components shown in FIG. 17 such as a processor 1712 and a processor 1722, respectively, for example. Each of apparatus 1710 and apparatus 1720 may further include one or more other components not pertinent to the proposed scheme of the present disclosure (e.g., internal power supply, display device and/or user interface device), and, thus, such component(s) of apparatus 1710 and apparatus 1720 are neither shown in FIG. 17 nor described below in the interest of simplicity and brevity.

In one aspect, each of processor 1712 and processor 1722 may be implemented in the form of one or more single-core processors, one or more multi-core processors, one or more RISC processors or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including those pertaining to designs of a segment parser and transmission methods for dRUs on wider bandwidths in wireless communications in accordance with various implementations of the present disclosure. For instance, each of processor 1712 and 1722 may be configured with electronic circuitry implementing one or more of the designs of a transmitter block diagram with a segment parser (e.g., a round robin or proportional round robin segment parser) for transmission of dRUs on a wider bandwidth shown in FIG. 2, FIG. 3, FIG. 4 and FIG. 16.

In some implementations, apparatus 1710 may also include a transceiver 1716 coupled to processor 1712. Transceiver 1716 may include a transmitter capable of wirelessly transmitting and a receiver capable of wirelessly receiving data. In some implementations, apparatus 1720 may also include a transceiver 1726 coupled to processor 1722. Transceiver 1726 may include a transmitter capable of wirelessly transmitting and a receiver capable of wirelessly receiving data. It is noteworthy that, although transceiver 1716 and transceiver 1726 are illustrated as being external to and separate from processor 1712 and processor 1722, respectively, in some implementations, transceiver 1716 may be an integral part of processor 1712 as a system on chip (SoC) and/or transceiver 1726 may be an integral part of processor 1722 as a SoC.

In some implementations, apparatus 1710 may further include a memory 1714 coupled to processor 1712 and capable of being accessed by processor 1712 and storing data therein. In some implementations, apparatus 1720 may further include a memory 1724 coupled to processor 1722 and capable of being accessed by processor 1722 and storing data therein. Each of memory 1714 and memory 1724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1714 and memory 1724 may include a type of read-only memory (ROM) such as mask ROM, programmable ROM (PROM), erasable programmable ROM (EPROM) and/or electrically erasable programmable ROM (EEPROM). Alternatively, or additionally, each of memory 1714 and memory 1724 may include a type of non-volatile random-access memory (NVRAM) such as flash memory, solid-state memory, ferroelectric RAM (FeRAM), magnetoresistive RAM (MRAM) and/or phase-change memory.

Each of apparatus 1710 and apparatus 1720 may be a communication entity capable of communicating with each other using various proposed schemes in accordance with the present disclosure. For illustrative purposes and without limitation, a description of capabilities of apparatus 1710, as STA 110, and apparatus 1720, as STA 120, is provided below in the context of process 1800. It is noteworthy that, although a detailed description of capabilities, functionalities and/or technical features of apparatus 1710 is provided below, the same may be applied to apparatus 1720 although a detailed description thereof is not provided solely in the interest of brevity. It is also noteworthy that, although the example implementations described below are provided in the context of WLAN, the same may be implemented in other types of networks.

### Illustrative Processes

FIG. 18 illustrates an example process 1800 in accordance with an implementation of the present disclosure. Process 1800 may represent an aspect of implementing various proposed designs, concepts, schemes, systems and methods described above. More specifically, process 1800 may represent an aspect of the proposed concepts and schemes pertaining to designs of a segment parser and transmission methods for dRUs on wider bandwidths in wireless communications in accordance with the present disclosure. Process 1800 may include one or more operations, actions, or functions as illustrated by one or more of blocks 1810 and 1820. Although illustrated as discrete blocks, various blocks of process 1800 may be divided into additional blocks, combined into fewer blocks, or eliminated, depending on the desired implementation. Moreover, the blocks/sub-blocks of process 1800 may be executed in the order shown in FIG. 18 or, alternatively in a different order. Furthermore, one or more of the blocks/sub-blocks of process 1800 may be executed repeatedly or iteratively. Process 1800 may be implemented by or in apparatus 1710 and apparatus 1720 as well as any variations thereof. Solely for illustrative purposes and without limiting the scope, process 1800 is described below in the context of apparatus 1710 implemented in or as STA 110 and apparatus 1720 implemented in or as STA 120 of a wireless network such as a WLAN in network environment 100 in accordance with one or more of IEEE 802.11 standards. Process 1800 may begin at block 1810.

At 1810, process 1800 may involve processor 1712 of apparatus 1710 (e.g., STA 110) generating a dRU by segment parsing data tones of the dRU onto multiple 80 MHz segments using a segment parser (e.g., a round robin or proportional round robin segment parser). For instance, the segment parsing may involve segment parsing the data tones of the dRU onto: (i) two 80 MHz segments responsive to the distribution bandwidth being 160 MHz; or (ii) three 80 MHz segments responsive to the bandwidth being 240 MHz; or (iii) four 80 MHz segments responsive to the distribution bandwidth being 320 MHz; or (iv) six 80 MHz segments responsive to the bandwidth being 480 MHz. Process 1800 may proceed from 1810 to 1820.

At 1820, process 1800 may involve processor 1712 transmitting, via transceiver 1716, the dRU (e.g., to apparatus 1720 as STA 120) on a distribution bandwidth that is equal to or greater than 160 MHz.

In some implementations (Option-1), in generating the dRU, process 1800 may further involve processor 1712 performing additional operations. For instance, process 1800 may involve processor 1712 stream parsing a stream of bits into a first spatial stream of the data tones of the dRU and a second spatial stream of the data tones of the dRU or another number of spatial streams of the data tones of the dRU. For each of the first and second or other spatial streams, process 1800 may involve processor 1712 either: (a) segment parsing the data tones responsive to a size of the dRU being greater than 996 tones; or (b) bypassing the segment parsing responsive to the size of the dRU being equal to or less than 996 tones. Additionally, process 1800 may involve processor 1712 processing the data tones through two of a BCC interleaver, a constellation mapper and a LDPC tone mapper such that: (a) the BCC interleaver is bypassed in an event that the LDPC tone mapper is applied; or (b) the LDPC tone mapper is bypassed in an event that the BCC interleaver is applied. Furthermore, process 1800 may involve processor 1712 either: (a) segment deparsing the data tones responsive to the size of the dRU being greater than 996 tones; or (b) bypassing the segment deparsing responsive to the size of the dRU being equal to or less than 996 tones.

In some implementations (Option-1), in generating the dRU, process 1800 may further involve processor 1712 performing additional operations. For instance, process 1800 may involve processor 1712 stream parsing a stream of bits into a first spatial stream of the data tones of the dRU and a second spatial stream of the data tones of the dRU or another number of spatial streams of the data tones of the dRU. For each of the first and second or other spatial streams, process 1800 may involve processor 1712 either: (a) enabling a segment parser to segment parse the data tones into a first 996-tone dRU and a second 996-tone dRU responsive to a size of the dRU being equal to 2×996 tones; or (b) not enabling the segment parser responsive to the size of the dRU being less than 2×996 tones. Moreover, process 1800 may involve processor 1712 processing each of the first 996-tone dRU and the second 996-tone dRU through a constellation mapper and a LDPC tone mapper. Additionally, process 1800 may involve processor 1712 segment deparsing the data tones of the first 996-tone dRU and the second 996-tone dRU by a segment deparser. In some implementations, the segment parser may include a round robin or proportional round robin segment parser, and the segment deparser may include a round robin or proportional round robin segment deparser. In some implementations, wherein the distribution bandwidth on which the dRU may be transmitted is 320 MHz or 480 MHz.

In some implementations (Option-2), in generating the dRU, process 1800 may further involve processor 1712 performing additional operations. For instance, process 1800 may involve processor 1712 stream parsing a stream of bits into a first spatial stream of the data tones of the dRU and a second spatial stream of the data tones of the dRU or another number of spatial streams of the data tones of the dRU. For each of the first and second or other spatial streams, process 1800 may involve processor 1712 either: (a) enabling a segment parser to segment parse the data tones responsive to a size of the distribution bandwidth being greater than or equal to 160 MHz; or (b) not enabling the segment parser responsive to the size of the distribution bandwidth being less than 160 MHz. Additionally, process 1800 may involve processor 1712 processing the data tones through two of a BCC interleaver, a constellation mapper and a LDPC tone mapper such that: (a) the BCC interleaver is bypassed in an event that the LDPC tone mapper is applied; or (b) the LDPC tone mapper is bypassed in an event that the BCC interleaver is applied. Moreover, process 1800 may involve processor 1712 segment deparsing the data tones. In some implementations, the segment parser may include a round robin segment parser or a proportional round robin segment parser.

In some implementations, in an event that the distribution bandwidth is 160 MHz, a number of data subcarriers parsed onto each 80 MHz segment may be: (a) 51 responsive to a size of the dRU being 106 tones; (b) 117 responsive to the size of the dRU being 242 tones; (c) 234 responsive to the size of the dRU being 484 tones; or (d) 490 responsive to the size of the dRU being 996 tones. In an event that the distribution bandwidth is 240 MHz, the number of data subcarriers parsed onto each 80 MHz segment may be: (a) 34 responsive to a size of the dRU being 106 tones; (b) 78 responsive to the size of the dRU being 242 tones; (c) 156 responsive to the size of the dRU being 484 tones; or (d) 326 with 2 leftover tones responsive to the size of the dRU being 996 tones. In an event that the distribution bandwidth is 320 MHz, the number of data subcarriers parsed onto each 80 MHz segment may be: (a) 117 responsive to the size of the dRU being 484 tones; (b) 245 responsive to the size of the dRU being 996 tones; or (c) 490 responsive to the size of the dRU being 2×996 tones. In an event that the distribution bandwidth is 480 MHz, the number of data subcarriers parsed onto each 80 MHz segment may be: (a) 39 responsive to the size of the dRU being 242 tones; (b) 78 responsive to the size of the dRU being 484 tones; (c) 163 with 2 leftover tones responsive to the size of the dRU being 996 tones; or (d) 326 with 4 leftover tones responsive to the size of the dRU being 2×996 tones.

In some implementations, responsive to there being leftover tones, in segment parsing, process 1800 may involve processor 1712 parsing encoded information bits onto each 80 MHz segment as follows: (a) in an event that a size of the dRU is 996 tones and a size of the distribution bandwidth is 240 MHz, parsing 980 data tones into 320 data tones on a first 80 MHz segment+330 data tones on a second 80 MHz segment+330 data tones on a third 80 MHz segment; or (b) in an event that the size of the dRU is 996 tones and the size of the distribution bandwidth is 480 MHz, parsing the 980 data tones into 155 data tones+165 data tones+165 data tones+165 data tones+165 data tones+165 data tones; or (c) in an event that the size of the dRU is 996 tones and the size of the distribution bandwidth is 480 MHz, parsing the 980 data tones into 160 data tones+160 data tones+165 data tones+165 data tones+165 data tones+165 data tones; or (d) in an event that the size of the dRU is 2×996 tones and the size of the distribution bandwidth is 480 MHz, parsing 2×980 data tones into 320 data tones+320 data tones+330 data tones+330 data tones+330 data tones+330 data tones; or (e) in an event that the size of the dRU is 2×996 tones and the size of the distribution bandwidth is 480 MHz, parsing the 2×980 data tones into 310 data tones+330 data tones+330 data tones+330 data tones+330 data tones+330 data tones.

In some implementations, in an event that a size of the dRU is 996 tones and the distribution bandwidth is 240 MHz, leftover bits may be processed in a round robin fashion and evenly distributed over last two 80 MHz segments of the multiple 80 MHz segments.

In some implementations, in an event that a size of the dRU is 996 tones or 2×996 tones and the distribution bandwidth is 480 MHz, leftover bits may be processed in a round robin fashion and evenly distributed over last five 80 MHz segments of the multiple 80 MHz segments.

In some implementations, the BCC interleaver may be applied responsive to a size of the dRU being less than or equal to 242 tones. Moreover, in an event that a size of the distribution bandwidth is 160 MHz and the size of the dRU is 106 tones: N_{sd/seq}=51; N_{col}=17; N_{row}=3×N_{BPSCS}; and Nᵣₒₜ=11. Alternatively, in an event that the size of the distribution bandwidth is 160 MHz and the size of the dRU is 242 tones: N_{sd/seq}=117; N_{col}=13; N_{row}=9×N_{BPSCS}; and Nᵣₒₜ=29. Alternatively, in an event that the size of the distribution bandwidth is 240 MHz and the size of the dRU is 106 tones: N_{sd/seg}=34; N_{col}=17; N_{row}=2×N_{BPSCS}; and Nᵣₒₜ=7 or 9 or 11. Alternatively, in an event that the size of the distribution bandwidth is 240 MHz and the size of the dRU is 242 tones: N_{sd/seg}=78; N_{col}=13; N_{row}=6×N_{BPSCS}; and Nᵣₒₜ=19. Alternatively, in an event that the size of the distribution bandwidth is 480 MHz and the size of the dRU is 242 tones: N_{sd/seg}=39; N_{col}=13; N_{row}=3×N_{BPSCS}; and Nᵣₒₜ=9. Here, N_{sd/seg} denotes a number of subcarriers used in data transmission per 80 MHz segment, N_{col} denotes a number of columns, N_{row} denotes a number of rows, Nᵣₒₜ denotes a number of rotations, and N_{BPSCS} denotes a number of coded bits per subcarrier per spatial stream.

In some implementations, in an event that the LDPC tone mapper is applied: (a) a number of subcarriers used in data transmission per 80 MHz segment is 51, 117, 234 or 490 responsive to a size of the dRU being 106 tones, 242 tones, 484 tones or 996 tones, respectively, in an event that a size of the distribution bandwidth is 160 MHz; (b) the number of subcarriers used in data transmission per 80 MHz segment is 34, 78, 156 or 326 responsive to a size of the dRU being 106 tones, 242 tones, 484 tones or 996 tones, respectively, in an event that a size of the distribution bandwidth is 240 MHz, with 2 leftover tones in case of the size of the dRU being 996 tones; (c) the number of subcarriers used in data transmission per 80 MHz segment is 117, 245 or 490 responsive to a size of the dRU being 484 tones, 996 tones or 2×996 tones, respectively, in an event that a size of the distribution bandwidth is 320 MHz; or (d) the number of subcarriers used in data transmission per 80 MHz segment is 39, 78, 163 or 326 responsive to a size of the dRU being 242 tones, 484 tones, 996 tones or 2×996 tones, respectively, in an event that a size of the distribution bandwidth is 480 MHz, with 2 leftover tones in case of the size of the dRU being 996 tones or with 4 leftover tones in case of the size of the dRU being 2×996 tones.

In some implementations, in an event that a size of the distribution bandwidth is 160 MHz and that the LDPC tone mapper is applied: (a) a number of subcarriers used in data transmission per 80 MHz segment (N_{sd/seg) is} 51, 117, 234 or 490 responsive to a size of the dRU being 106 tones, 242 tones, 484 tones or 996 tones, respectively. Moreover, a LDPC tone mapping distance (Dₜₘ) is 3, 9, 9 or 14 responsive to a size of the dRU being 106 tones, 242 tones, 484 tones or 996 tones, respectively.

In some implementations, in an event that a size of the distribution bandwidth is 240 MHz and that the LDPC tone mapper is applied: (a) in an event that a size of the dRU is 106 tones: N_{sd/seg}=34; and Dₜₘ=2; (b) in an event that a size of the dRU is 242 tones: N_{sd/seg}=78; and Dₜₘ=6 or 3; (c) in an event that a size of the dRU is 484 tones: N_{sd/seg}=156; and Dₜₘ=6 or 12 or 13; (d) in an event that a size of the dRU is 996 tones: N_{sd/seg={}320, 330, 330}; and Dₜₘ=10. Here, N_{sd/seg} denotes a number of subcarriers used in data transmission per 80 MHz segment, and Dₜₘ denotes a LDPC tone mapping distance.

In some implementations, in an event that a size of the distribution bandwidth is 320 MHz and that the LDPC tone mapper is applied: N_{sd/seg} is 117, 245 or 490 responsive to a size of the dRU being 484 tones, 996 tones or 2×996 tones, respectively; and Dₜₘ is 9, 7 or 14 responsive to a size of the dRU being 484 tones, 996 tones or 2×996 tones, respectively.

In some implementations, in in an event that a size of the distribution bandwidth is 480 MHz and that the LDPC tone mapper is applied: (a) in an event that a size of the dRU is 242 tones: N_{sd/seg}=39; and Dₜₘ=2; (b) in an event that a size of the dRU is 484 tones: N_{sd/seg}=78; and Dₜₘ=6 or 3; (c) in an event that a size of the dRU is 996 tones: N_{sd/seg}={155, 165, 165, 165, 165, 165} or {160, 160, 165, 165, 165, 165}; and Dₜₘ=5; (d) in an event that a size of the dRU is 2×996 tones: N_{sd/seg}={320, 320, 330, 330, 330, 330} or {310, 330, 330, 330, 330, 330}; and Dₜₘ=10. Here, N_{sd/seg} denotes a number of subcarriers used in data transmission per 80 MHz segment, and Dₜₘ denotes a LDPC tone mapping distance.

In some implementations (Option-3), in generating the dRU, process 1800 may further involve processor 1712 performing additional operations. For instance, process 1800 may involve processor 1712 stream parsing a stream of bits into a first spatial stream of the data tones of the dRU and a second spatial stream of the data tones of the dRU or another number of spatial streams of the data tones of the dRU. For each of the first and second or other spatial streams, process 1800 may involve processor 1712 either: (a) enabling a segment parser to segment parse the data tones responsive to a size of the distribution bandwidth being greater than or equal to 160 MHz; or (b) not enabling the segment parser responsive to the size of the distribution bandwidth being less than 160 MHz. Additionally, process 1800 may involve processor 1712 processing the data tones through a BCC interleaver and a constellation mapper. Moreover, process 1800 may involve processor 1712 segment deparsing the data tones. Furthermore, process 1800 may involve processor 1712 performing LDPC tone mapping on the data tones using a LDPC tone mapper such that: (a) the BCC interleaver is bypassed in an event that the LDPC tone mapper is applied; or (b) the LDPC tone mapper is bypassed in an event that the BCC interleaver is applied. In some implementations, the segment parser may include a round robin segment parser or a proportional round robin segment parser.

In some implementations, in performing the LDPC tone mapping, process 1800 may involve processor 1712 segment deparsing first and then performing joined-segment LDPC tone mapping responsive to a size of the dRU being equal to or less than 996 tones. Alternatively, in performing the LDPC tone mapping, process 1800 may involve processor 1712, after segment deparsing, performing the LDPC tone mapping on each of two 996-tone dRUs responsive to the size of the dRU being 2×996 tones.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a distributed-tone resource unit (dRU); and
transmitting the dRU on a distribution bandwidth that is equal to or greater than 160 MHz,
wherein the generating comprises segment parsing data tones of the dRU onto multiple 80 MHz segments using a round robin or proportional round robin segment parser.

2. The method of claim 1, wherein the generating further comprises:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
segment parsing the data tones responsive to a size of the dRU being greater than 996 tones; or
bypassing the segment parsing responsive to the size of the dRU being equal to or less than 996 tones;
processing the data tones through two of a binary convolutional coding (BCC) interleaver, a constellation mapper and a low-density parity-check (LDPC) tone mapper such that:
the BCC interleaver is bypassed in an event that the LDPC tone mapper is applied; or
the LDPC tone mapper is bypassed in an event that the BCC interleaver is applied; and
either:
segment deparsing the data tones responsive to the size of the dRU being greater than 996 tones; or
bypassing the segment deparsing responsive to the size of the dRU being equal to or less than 996 tones.

3. The method of claim 1, wherein the generating further comprises:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
enabling a segment parser to segment parse the data tones into a first 996-tone dRU and a second 996-tone dRU responsive to a size of the dRU being equal to 2×996 tones; or
not enabling the segment parser responsive to the size of the dRU being less than 2×996 tones;
processing each of the first 996-tone dRU and the second 996-tone dRU through a constellation mapper and a low-density parity-check (LDPC) tone mapper; and
segment deparsing the data tones of the first 996-tone dRU and the second 996-tone dRU by a segment deparser,
wherein the segment parser comprises a round robin segment parser,
wherein the segment deparser comprises a round robin segment deparser, and
wherein the bandwidth on which the dRU is transmitted is 320 MHz or 480 MHz.

4. The method of claim 1, wherein the generating further comprises:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
enabling a segment parser to segment parse the data tones responsive to a size of the bandwidth being greater than or equal to 160 MHz; or
not enabling the segment parser responsive to the size of the distribution bandwidth being less than 160 MHz;
processing the data tones through two of a binary convolutional coding (BCC) interleaver, a constellation mapper and a low-density parity-check (LDPC) tone mapper such that:
the BCC interleaver is bypassed in an event that the LDPC tone mapper is applied; or
the LDPC tone mapper is bypassed in an event that the BCC interleaver is applied; and
segment deparsing the data tones,
wherein the segment parser comprises a round robin segment parser or a proportional round robin segment parser.

5. The method of claim 4, wherein:
in an event that the distribution bandwidth is 160 MHz, a number of data subcarriers parsed onto each 80 MHz segment comprises: 51 responsive to a size of the dRU being 106 tones; or 117 responsive to the size of the dRU being 242 tones; or 234 responsive to the size of the dRU being 484 tones; or 490 responsive to the size of the dRU being 996 tones,
in an event that the distribution bandwidth is 240 MHz, the number of data subcarriers parsed onto each 80 MHz segment comprises: 34 responsive to a size of the dRU being 106 tones; or 78 responsive to the size of the dRU being 242 tones; or 156 responsive to the size of the dRU being 484 tones; or 326 with 2 leftover tones responsive to the size of the dRU being 996 tones,
in an event that the distribution bandwidth is 320 MHz, the number of data subcarriers parsed onto each 80 MHz segment comprises: 117 responsive to the size of the dRU being 484 tones; or 245 responsive to the size of the dRU being 996 tones; or 490 responsive to the size of the dRU being 2×996 tones,
in an event that the distribution bandwidth is 480 MHz, the number of data subcarriers parsed onto each 80 MHz segment comprises: 39 responsive to the size of the dRU being 242 tones; or 78 responsive to the size of the dRU being 484 tones; or 163 with 2 leftover tones responsive to the size of the dRU being 996 tones; or 326 with 4 leftover tones responsive to the size of the dRU being 2×996 tones.

6. The method of claim 4, wherein, responsive to there being leftover tones, the segment parsing comprises parsing encoded information bits onto each 80 MHz segment by:
in an event that a size of the dRU is 996 tones and a size of the distribution bandwidth is 240 MHz, parsing 980 data tones into 320 data tones on a first 80 MHz segment+330 data tones on a second 80 MHz segment+330 data tones on a third 80 MHz segment; or
in an event that the size of the dRU is 996 tones and the size of the distribution bandwidth is 480 MHz, parsing the 980 data tones into 155 data tones+165 data tones+165 data tones+165 data tones+165 data tones+165 data tones; or
in an event that the size of the dRU is 996 tones and the size of the distribution bandwidth is 480 MHz, parsing the 980 data tones into 160 data tones+160 data tones+165 data tones+165 data tones+165 data tones+165 data tones; or
in an event that the size of the dRU is 2×996 tones and the size of the distribution bandwidth is 480 MHz, parsing 2×980 data tones into 320 data tones+320 data tones+330 data tones+330 data tones+330 data tones+330 data tones; or
in an event that the size of the dRU is 2×996 tones and the size of the distribution bandwidth is 480 MHz, parsing the 2×980 data tones into 310 data tones+330 data tones+330 data tones+330 data tones+330 data tones+330 data tones.

7. The method of claim 4, wherein, in an event that a size of the dRU is 996 tones and the distribution bandwidth is 240 MHz, leftover bits are processed in a round robin fashion and evenly distributed over last two 80 MHz segments of the multiple 80 MHz segments.

8. The method of claim 4, wherein, in an event that a size of the dRU is 996 tones or 2×996 tones and the distribution bandwidth is 480 MHz, leftover bits are processed in a round robin fashion and evenly distributed over last five 80 MHz segments of the multiple 80 MHz segments.

9. The method of claim 4, wherein the BCC interleaver is applied responsive to a size of the dRU being less than or equal to 242 tones, and wherein:
in an event that a size of the distribution bandwidth is 160 MHz and the size of the dRU is 106 tones:
$${N}_{sd / seg} = 51 ; \\ {N}_{col} = 17 ; \\ {N}_{row} = 3 \times {N}_{BPSCS} ; and$$
$${N}_{rot} = 11 ;$$
in an event that the size of the distribution bandwidth is 160 MHz and the size of the dRU is 242 tones:
$${N}_{sd / seg} = 117 ; \\ {N}_{col} = 13 ; \\ {N}_{row} = 9 \times {N}_{BPSCS} ; and$$
$${N}_{rot} = 29 ;$$
in an event that the size of the distribution bandwidth is 240 MHz and the size of the dRU is 106 tones:
$${N}_{sd / seg} = 34 ; \\ {N}_{col} = 17 ; \\ {N}_{row} = 2 \times {N}_{BPSCS} ; and$$
$${N}_{rot} = 7 or 9 or 11 ;$$
in an event that the size of the distribution bandwidth is 240 MHz and the size of the dRU is 242 tones:
$${N}_{sd / seg} = 78 ; \\ {N}_{col} = 13 ; \\ {N}_{row} = 6 \times {N}_{BPSCS} ; and$$
$${N}_{rot} = 19 ;$$
in an event that the size of the distribution bandwidth is 480 MHz and the size of the dRU is 242 tones:
$${N}_{sd / seg} = 39 ; \\ {N}_{col} = 13 ; \\ {N}_{row} = 3 \times {N}_{BPSCS} ; and$$
$${N}_{rot} = 9 ;$$
N_{sd/seg} denotes a number of subcarriers used in data transmission per 80 MHz segment,
N_{col} denotes a number of columns,
N_{row} denotes a number of rows,
Nᵣₒₜ denotes a number of rotations, and
N_{BPSCS} denotes a number of coded bits per subcarrier per spatial stream.

10. The method of claim 4, wherein, in an event that the LDPC tone mapper is applied:
a number of subcarriers used in data transmission per 80 MHz segment is 51, 117, 234 or 490 responsive to a size of the dRU being 106 tones, 242 tones, 484 tones or 996 tones, respectively, in an event that a size of the distribution bandwidth is 160 MHz; or
the number of subcarriers used in data transmission per 80 MHz segment is 34, 78, 156 or 326 responsive to a size of the dRU being 106 tones, 242 tones, 484 tones or 996 tones, respectively, in an event that a size of the distribution bandwidth is 240 MHz, with 2 leftover tones in case of the size of the dRU being 996 tones; or
the number of subcarriers used in data transmission per 80 MHz segment is 117, 245 or 490 responsive to a size of the dRU being 484 tones, 996 tones or 2×996 tones, respectively, in an event that a size of the distribution bandwidth is 320 MHz; or
the number of subcarriers used in data transmission per 80 MHz segment is 39, 78, 163 or 326 responsive to a size of the dRU being 242 tones, 484 tones, 996 tones or 2×996 tones, respectively, in an event that a size of the distribution bandwidth is 480 MHz, with 2 leftover tones in case of the size of the dRU being 996 tones or with 4 leftover tones in case of the size of the dRU being 2×996 tones.

11. The method of claim 4, wherein, in an event that a size of the distribution bandwidth is 160 MHz and that the LDPC tone mapper is applied:
a number of subcarriers used in data transmission per 80 MHz segment (N_{sd/seg}) is 51, 117, 234 or 490 responsive to a size of the dRU being 106 tones, 242 tones, 484 tones or 996 tones, respectively; and
a LDPC tone mapping distance (Dₜₘ) is 3, 9, 9 or 14 responsive to a size of the dRU being 106 tones, 242 tones, 484 tones or 996 tones, respectively.

12. The method of claim 4, wherein, in an event that a size of the distribution bandwidth is 240 MHz and that the LDPC tone mapper is applied:
in an event that a size of the dRU is 106 tones:
N_{sd/seg}=34; and
Dₜₘ=2;
in an event that a size of the dRU is 242 tones:
N_{sd/seg}=78; and
Dₜₘ=6 or 3;
in an event that a size of the dRU is 484 tones:
N_{sd/seg}=156; and
Dₜₘ=6 or 12 or 13;
in an event that a size of the dRU is 996 tones:
N_{sd/seg}={320, 330, 330}; and
Dₜₘ=10,
N_{sd/seg} denotes a number of subcarriers used in data transmission per 80 MHz segment, and
Dₜₘ denotes a LDPC tone mapping distance.

13. The method of claim 4, wherein, in an event that a size of the distribution bandwidth is 320 MHz and that the LDPC tone mapper is applied:
a number of subcarriers used in data transmission per 80 MHz segment (N_{sd/seg}) is 117, 245 or 490 responsive to a size of the dRU being 484 tones, 996 tones or 2×996 tones, respectively; and
a LDPC tone mapping distance (Dₜₘ) is 9, 7 or 14 responsive to a size of the dRU being 484 tones, 996 tones or 2×996 tones, respectively.

14. The method of claim 4, wherein, in an event that a size of the distribution bandwidth is 480 MHz and that the LDPC tone mapper is applied:
in an event that a size of the dRU is 242 tones:
N_{sd/seg}=39; and
Dₜₘ=2;
in an event that a size of the dRU is 484 tones:
N_{sd/seg}=78; and
Dₜₘ=6 or 3;
in an event that a size of the dRU is 996 tones:
N_{sd/seg}={155, 165, 165, 165, 165, 165] or {160, 160, 165, 165, 165, 165}; and
Dₜₘ=5;
in an event that a size of the dRU is 2×996 tones:
N_{sd/seg}={320, 320, 330, 330, 330, 330] or {310, 330, 330, 330, 330, 330}; and
Dₜₘ=10,
N_{sd/seg} denotes a number of subcarriers used in data transmission per 80 MHz segment, and
Dₜₘ denotes a LDPC tone mapping distance.

15. The method of claim 1, wherein the generating further comprises:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
enabling a segment parser to segment parse the data tones responsive to a size of the distribution bandwidth being greater than or equal to 160 MHz; or
not enabling the segment parser responsive to the size of the distribution bandwidth being less than 160 MHz;
processing the data tones through a binary convolutional coding (BCC) interleaver and a constellation mapper;
segment deparsing the data tones; and
performing low-density parity-check (LDPC) tone mapping on the data tones using a LDPC tone mapper such that:
the BCC interleaver is bypassed in an event that the LDPC tone mapper is applied; or
the LDPC tone mapper is bypassed in an event that the BCC interleaver is applied,
wherein the segment parser comprises a round robin segment parser or a proportional round robin segment parser.

16. The method of claim 15, wherein the performing of the LDPC tone mapping comprises:
responsive to a size of the dRU being equal to or less than 996 tones, segment deparsing first and then performing joined-segment LDPC tone mapping; or
responsive to the size of the dRU being 2×996 tones, after segment deparsing, performing the LDPC tone mapping on each of two 996-tone dRUs.

17. An apparatus, comprising:
a transceiver configured to communicate wirelessly; and
a processor coupled to the transceiver and configured to perform operations comprising:
generating a distributed-tone resource unit (dRU); and
transmitting, via the transceiver, the dRU on a distribution bandwidth that is equal to or greater than 160 MHz,
wherein the generating comprises segment parsing data tones of the dRU onto multiple 80 MHz segments using a segment parser, and
wherein the segment parsing comprises segment parsing the data tones of the dRU onto:
two 80 MHz segments responsive to the distribution bandwidth being 160 MHz; or
three 80 MHz segments responsive to the distribution bandwidth being 240 MHz; or
four 80 MHz segments responsive to the distribution bandwidth being 320 MHz; or
six 80 MHz segments responsive to the distribution bandwidth being 480 MHz.

18. The apparatus of claim 17, wherein, in generating the dRU the processor is further configured to perform operations comprising:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
segment parsing the data tones responsive to a size of the dRU being greater than 996 tones; or
bypassing the segment parsing responsive to the size of the dRU being equal to or less than 996 tones;
processing the data tones through two of a binary convolutional coding (BCC) interleaver, a constellation mapper and a low-density parity-check (LDPC) tone mapper such that:
the BCC interleaver is bypassed in an event that the LDPC tone mapper is applied; or
the LDPC tone mapper is bypassed in an event that the BCC interleaver is applied; and
either:
segment deparsing the data tones responsive to the size of the dRU being greater than 996 tones; or
bypassing the segment deparsing responsive to the size of the dRU being equal to or less than 996 tones.

19. The apparatus of claim 17, wherein, in generating the dRU the processor is further configured to perform operations comprising:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
enabling a segment parser to segment parse the data tones into a first 996-tone dRU and a second 996-tone dRU responsive to a size of the dRU being equal to 2×996 tones; or
not enabling the segment parser responsive to the size of the dRU being less than 2×996 tones;
processing each of the first 996-tone dRU and the second 996-tone dRU through a constellation mapper and a low-density parity-check (LDPC) tone mapper; and
segment deparsing the data tones of the first 996-tone dRU and the second 996-tone dRU by a segment deparser,
wherein the segment parser comprises a round robin segment parser,
wherein the segment deparser comprises a round robin segment deparser, and
wherein the distribution bandwidth on which the dRU is transmitted is 320 MHz or 480 MHz.

20. The apparatus of claim 17, wherein, in generating the dRU the processor is further configured to perform operations comprising:
stream parsing a stream of bits into a first spatial stream of the data tones of the dRU and a second spatial stream of the data tones of the dRU or another number of spatial streams of the data tones of the dRU; and
for each of the first and second or other spatial streams:
either:
enabling a segment parser to segment parse the data tones responsive to a size of the distribution bandwidth being greater than or equal to 160 MHz; or
not enabling the segment parser responsive to the size of the distribution bandwidth being less than 160 MHz;
processing the data tones through two of a binary convolutional coding (BCC) interleaver, a constellation mapper and a low-density parity-check (LDPC) tone mapper such that:
the BCC interleaver is bypassed in an event that the LDPC tone mapper is applied; or
the LDPC tone mapper is bypassed in an event that the BCC interleaver is applied; and
segment deparsing the data tones,
wherein the segment parser comprises a round robin segment parser or a proportional round robin segment parser.
